(19) United States
(12) Patent Application Publication
(10) Pub. No.: US 2020/0033464 A1
(43) Pub. Date: Jan. 30, 2020

(54) DISTANCE MEASURING DEVICE INCLUDING PLASMA TRANSMITTER FOR TIME SYNCHRONIZED SOUND AND RADIO SIGNALS

(71) Applicant: Sony Mobile Communications Inc, Tokyo (JP)

(72) Inventors: Mattias FALK, Tokyo (JP); Thomas FÄNGE, Tokyo (JP); Hannes BERGKVIST, Tokyo (JP); Ivar BERGKVIST, Tokyo (JP)

(21) Appl. No.: 16/422,001

(22) Filed: May 24, 2019

(30) Foreign Application Priority Data
Jul. 26, 2018 (SE) 1830223-2

(51) Int. Cl. G01S 11/16; G01S 11/02; G01S 11/14

(52) U.S. Cl. CPC G01S 11/16; G01S 11/14; G01S 11/02

(57) ABSTRACT

A distance measuring system is provided that includes a first device having a transmitter configured to simultaneously transmit an electromagnetic signal and a sound signal. The distance measuring system also includes a second device located at a distance from the first device. The second device is configured to receive the electromagnetic signal at a first time and receive the sound signal at a second time, and calculate the distance of the second device from the first device based on a difference between the first time and the second time.

### FIELD OF INVENTION

The present invention relates generally to distance measuring systems and more particularly to a distance measuring system using synchronized sound and radio signals.

### BACKGROUND OF THE INVENTION

Cricket is an indoor location or distance measuring system that uses a combination of radio frequency (RF) and ultrasound (US) technologies to provide location information, such as space identifiers, position coordinates, and orientation of objects to a host device. Cricket systems use two types of devices, including listeners and beacons, each having an RF transceiver, a microcontroller, and other associated hardware for generating and receiving US signals and interfacing with the host device.

Objects to be monitored are equipped with listeners, also referred to herein as receiving devices, to receive RF and US signals transmitted by various beacons, also referred to herein as transmitting devices, placed throughout an indoor area at fixed reference points. The objects to be monitored may be stationary or mobile. To determine the location of an object, or to measure the object's distance from a transmitting device, the transmitting device transmits an RF message. At the start of the RF message, the transmitting device also transmits a narrow US signal. When a receiving device receives both the RF signal and the US signal from a given transmission, the distance of the receiving device from the corresponding transmitting device may be calculated by taking into account the difference in arrival times of the RF and US signals, considering the propagation speeds of the RF signal (traveling at the speed of light) and the US signal (traveling at the speed of sound). In particular, the Cricket system measures the distance of a receiving device from a transmitting device by comparing the time of flight (ToF) of the RF and US signals.

Distance measuring systems, such as the Cricket system, are intended more for use indoors, where outdoor location systems, such as the Global Positioning System (GPS), do not work as well. Cricket systems, however, also may be used outdoors for localization of objects as long as the transmitting devices and receiving devices remain in line of sight of each other.

Conventional distance measuring systems and methods use transmitting devices with separate specific RF and US transmitters to transmit RF and US signals, respectively, from the transmitting device. For accurate measurement, it is desirable for the RF and US signals to be initiated simultaneously so that the signals may be transmitted as close to the same time as possible. Typical delays, however, such as group delay in the US transmitter, antenna delay in the RF transmitter, as well as other unknown delays in the system, may cause a discrepancy in the relative timing of transmission of the RF versus US signal after their simultaneous initiation. Such discrepancy in transmission timing of the RF and US signals may ultimately result in an error in the distance calculation.

Previous attempts have been made to reduce this calculation error by manually measuring delays in distance measuring systems and accounting for them in the distance calculation. For example, this may be done by detecting the difference in transmission timing of the RF and US signals using a digital oscilloscope connected to the transmitter and receiver units. Manually measuring delays, however, is time consuming, complicated and static as it cannot be done during normal system usage.

### SUMMARY OF THE INVENTION

The present invention provides a distance measuring system that is capable of reducing, or wholly eliminating, distance calculation errors caused by various delays in conventional distance measuring systems. According to aspects of the present invention, a distance measuring system is provided that uses a transmitting device capable of transmitting RF and US signals at exactly the same time so as to ensure continuous synchronization of RF and US signal transmission timing. In exemplary embodiments, the transmitting device is a plasma transmitter, which by its nature operates to simultaneously emit an RF signal and a US signal, thereby essentially eliminating the timing discrepancies that occur in conventional configurations. Aspects of the present invention, therefore, achieve more accurate distance calculations in distance measuring systems by reducing, or wholly eliminating, system delays and distance calculation errors.

According to an aspect of the invention, a distance measuring system is provided. The distance measuring system comprises a first device comprising a transmitter configured to simultaneously transmit an electromagnetic signal and a sound signal. The distance measuring system also comprises a second device located at a distance from the first device. The second device is configured to receive the electromagnetic signal at a first time and receive the sound signal at a second time, and calculate the distance of the second device from the first device based on a difference between the first time and the second time.

In an embodiment, the transmitter of the first device is a plasma transmitter.

In another embodiment, the plasma transmitter is a corona discharge transmitter.

In yet another embodiment, the second device of the distance measuring system comprises an electromagnetic receiver configured to receive the electromagnetic signal and a sound receiver configured to receive the sound signal.

In another embodiment, the electromagnetic receiver of the second device is a radio antenna and the sound receiver of the second device is a microphone.

In yet another embodiment, the second device of the distance measuring system comprises a single system receiver configured to receive both the electromagnetic signal and the sound signal.

In an embodiment, the single system receiver comprises a receiving plasma antenna.

In another embodiment, the single system receiver comprises a microphone having microphone circuitry. The microphone is configured to receive the sound signal and to receive the electromagnetic signal, and further is configured to detect the electromagnetic signal from electromagnetic interference in the microphone circuitry.

In yet another embodiment, the first device transmits the electromagnetic signal as a radio signal.

According to another aspect of the invention, a method of measuring distance is provided. The method comprises providing a first device and a second device located at a distance from each other. The method comprises simultaneously transmitting, by the first device, an electromagnetic signal and a sound signal. The method also comprises receiving, by the second device, the electromagnetic signal at a first time, and receiving, by the second device, the sound signal at a second time. The method then comprises calculating, by the second device, the distance of the second device from the first device based on a difference between the first time and the second time.

In an embodiment, the transmitter of the first device in the method is a plasma transmitter.

In another embodiment, the plasma transmitter is a corona discharge transmitter.

In an embodiment, the providing in the method comprises providing a second device that comprises an electromagnetic receiver for receiving the electromagnetic signal and a sound receiver for receiving the sound signal.

In another embodiment, the electromagnetic receiver is a radio antenna and the sound receiver is a microphone.

In yet another embodiment, the providing in the method comprises providing a second device that comprises a single system receiver configured to receive both the electromagnetic signal and the sound signal.

In an embodiment, the single system receiver is a receiving plasma antenna.

In another embodiment, the single system receiver comprises a microphone having microphone circuitry. The microphone is configured to receive the sound signal and to receive the electromagnetic signal, and further is configured to detect the electromagnetic signal from electromagnetic interference in the microphone circuitry.

In yet another embodiment, the transmitting in the method comprises transmitting the electromagnetic signal as a radio signal.

According to another aspect of the invention, a non-transitory computer-readable medium storing program code is provided which when executed performs the steps of simultaneously transmitting, by a first device, an electromagnetic signal and a sound signal, wherein the first device is located at a distance from a second device, receiving, by the second device, the electromagnetic signal at a first time, receiving, by the second device, the sound signal at a second time, and calculating, by the second device, the distance of the second device from the first device based on a difference between the first time and the second time.

According to an aspect of the invention, a first device located at a distance from a second device is provided. The first device comprises a transmitter configured to simultaneously transmit an electromagnetic signal and a sound signal. The electromagnetic signal is receivable by the second device at a first time and the sound signal is receivable by the second device at a second time, such that the distance of the second device from the first device is calculated based on a difference between the first time and the second time.

In an embodiment, the transmitter of the first device is a plasma transmitter.

In another embodiment, the plasma transmitter is a corona discharge transmitter.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1a is a schematic diagram of a conventional distance measuring system.

FIG. 1b is a timing diagram for a conventional distance calculation according to the distance measuring system depicted in FIG. 1a.

FIG. 2a is a schematic diagram of a distance measuring system according to an embodiment of the present invention.

FIG. 2b is a schematic diagram of a distance measuring system according to another embodiment of the present invention.

FIG. 2c is a timing diagram for a distance calculation according to the distance measuring systems depicted in FIGS. 2a-b.

FIG. 2d is a graphical representation of statistical results of distance calculations using systems such as those depicted in FIGS. 2a-b.

FIG. 3 is a schematic diagram of an exemplary transmitting device used in the distance measuring systems of FIGS. 2a-b.

FIG. 4 is a schematic flow diagram of a method of measuring distance according to an aspect of the present invention.

### DETAILED DESCRIPTION

Embodiments of the present invention will now be described with reference to the drawings, wherein like reference numerals are used to refer to like elements throughout. It will be understood that the figures are not necessarily to scale.

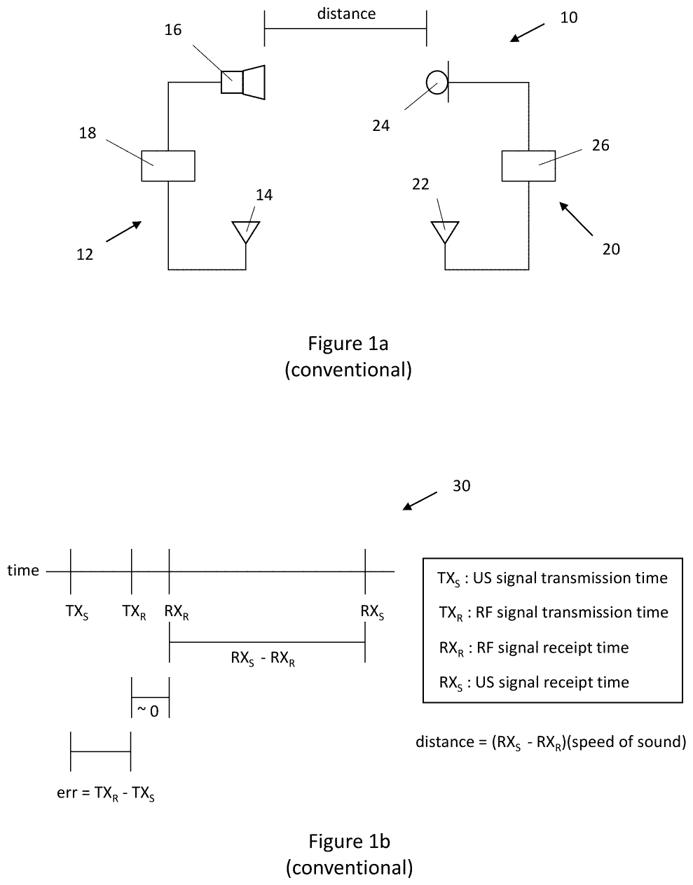

With reference to FIGS. 1a-b a conventional distance measuring system 10 and timing diagram 30 for a conventional distance calculation are depicted. In the conventional system 10, a conventional transmitting device 12 includes a conventional RF transmitter 14 for transmitting an RF signal, a conventional US transmitter 16 for transmitting a US signal, and a conventional transmitting device processor 18 for controlling the transmitting device 12. The conventional distance measuring system 10 may also include a conventional receiving device 20, located at a distance from the conventional transmitting device 10. The receiving device 20 may be positioned upon an object the distance to which is to be measured. The receiving device 20 includes a conventional RF receiver 22 for receiving the RF signal, a conventional US receiver 24 for receiving the US signal, and a conventional receiving device processor 26 for controlling the receiving device 20.

With reference to FIG. 1b, a conventional distance calculation schematic using a timing diagram 30 is depicted, showing how the distance of the receiving device 20 from the transmitting device 12 may be calculated. In the timing diagram 30, the US signal transmission time is depicted as TX_{S} and the RF signal transmission time is depicted as TX_{R}. The RF signal receipt time is depicted as RX_{R} and the US signal receipt time is depicted as RX_{S}. In the conventional distance measuring system 10, the difference in receipt time of the RF signal and US signal is considered to be the ToF of the sound, as the ToF of the RF signal is negligible with regards to the ToF of the US signal for the same distance. Therefore, using the speed of sound, the distance of the receiving device 20 from the transmitting device 12 may be calculated, for example by the formula: Distance=ToF_{S}×Speed of Sound, where ToF_{S}=RX_{S}−RX_{R}.

This conventional distance calculation, however, includes an error when one of a variety of delays in the conventional distance measuring system 10 causes a discrepancy in the transmission time of the RF signal relative to the transmission time of the US signal from the RF transmitter 14 and the US transmitter 16, respectively. With unknown transmission synchronization in the conventional distance measuring system 10, errors caused by delays such as group delay of the sound transmitter and antenna delay are introduced. In the timing diagram 30, this error is depicted as “err=TX_{R}−TX_{S}.” In an example, a system delay of even 0.1-0.2 ms may result in an error of several centimeters for any given distance calculation, which in many applications is unacceptably imprecise.

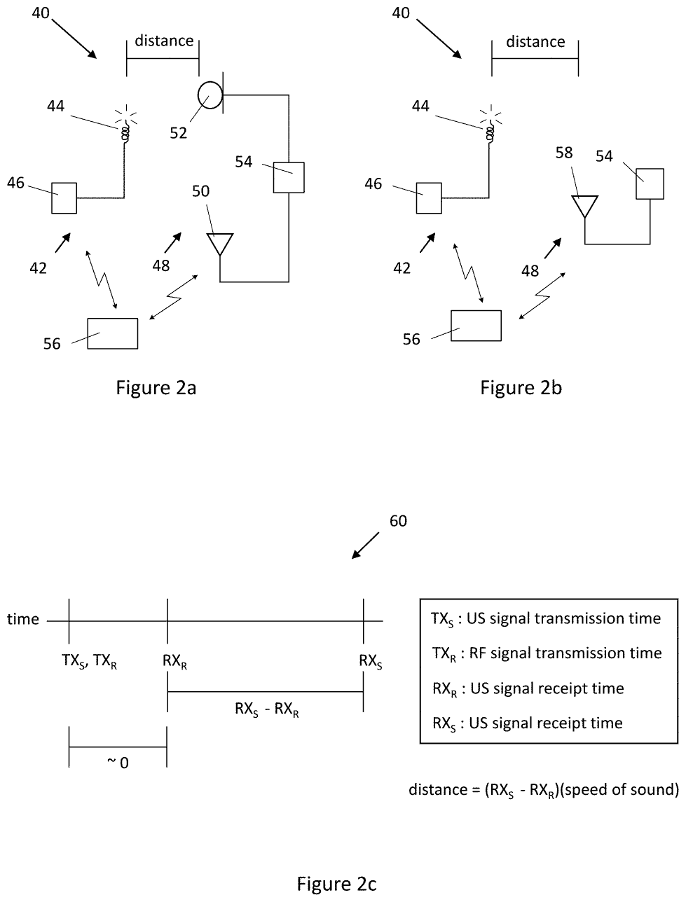

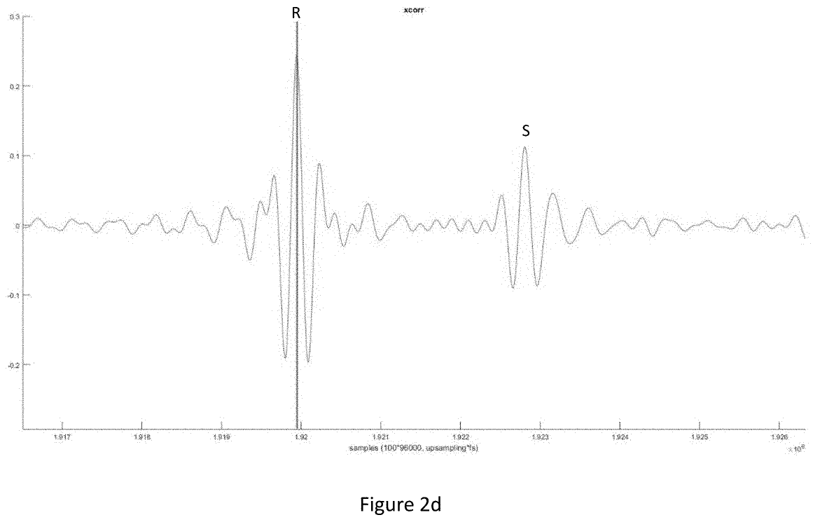

Accordingly, referring to FIGS. 2a-c, a distance measuring system 40 and timing diagram 60 according to an aspect of the present invention are depicted. The distance measuring system 40 comprises a first device, also referred to herein as a transmitting device 42, that includes a transmitter 44 configured to simultaneously transmit both an electromagnetic signal and a sound signal. The transmitter 44 of the transmitting device 42 is capable of simultaneous transmission of the electromagnetic and sound signals. In an embodiment, the transmitter 44 may be a plasma transmitter such as, for example, a corona discharge transmitter. The transmitter 44 may transmit the electromagnetic signal as, for example, a radio signal, also referred to herein as an RF signal. The transmitter 44 may transmit the sound signal as, for example, an ultrasound (US) signal. The sound, or US, signal may be transmitted within a wide range of frequencies. For example, the US signal may be transmitted in a frequency range of approximately 20-40 kHz, although the precise range is not critical. The electromagnetic, or RF, signal may be transmitted within a wide range of ordinary radio frequencies. For simplicity, RF and US will be used throughout to refer to the electromagnetic and sound signals, respectively, though it is to be understood that the electromagnetic and sound signals are not limited to RF and US signals, specifically, but may be any suitable electromagnetic or sound signal.

The transmitting device 42 also comprises a transmitting device processor 46 for controlling the transmitting device 42. The transmitting device processor 46 is configured to carry out overall control of the functions and operations of the transmitting device 42 and may be a central processing unit (CPU), microcontroller, or microprocessor.

The distance measuring system 40 further comprises a second device, also referred to herein as a receiving device 48, located at a distance from the transmitting device 42. Again, the receiving device 48 may be positioned upon an object the distance to which is to be measured. The receiving device 48 may be stationary or mobile, depending upon the object to which the receiving device 48 is fixed. The receiving device 48 is configured to receive the RF signal at a first time, also referred to herein as an RF signal receipt time. The receiving device 48 also is configured to receive the US signal at a second time, also referred to herein as a US signal receipt time. In an exemplary embodiment depicted in FIG. 2a, the receiving device 48 may include an electromagnetic receiver 50 for receiving the RF signal and a sound receiver 52 for receiving the US signal. The electromagnetic receiver 50 may be, for example, an RF receiver such as a radio antenna, and the sound receiver 52 may be, for example, a US receiver such as a microphone. In another exemplary embodiment depicted in FIG. 2b, the receiving device 48 may include a single system receiver 58 capable of receiving both the RF signal and the US signal. The single system receiver 58 may be, for example, a receiving plasma antenna. In another example, the single system receiver 58 may be a microphone having microphone circuitry that is subjected to interference by the RF signal. In this example, the microphone may receive the US signal as is conventional for a microphone, and further may receive the RF signal and detect the RF signal by recording the electromagnetic interference in the microphone circuitry. The receiving device 48 also comprises a receiving device processor 54 for controlling the receiving device 48. The receiving device processor 54 is configured to carry out overall control of the functions and operations of the receiving device 48 and may be a central processing unit (CPU), microcontroller, or microprocessor.

In various embodiments, the transmitting device processor 46, the receiving device processor 54, or both may be configured to calculate the distance of the receiving device 48 from the transmitting device 42. In another embodiment, the distance measuring system 40 may include a remote system processor 56 for calculating the distance of the receiving device 48 from the transmitting device 42, based on information received from the transmitting device processor 46 and/or the receiving device processor 54 regarding transmission and receipt of the RF and US signals. The remote system processor 56 may be in wireless or electrical communication with the transmitting device 42, the receiving device 48, or both. The remote system processor 56 may be configured to carry out overall control of the functions and operations of the distance measuring system 40 and may be a central processing unit (CPU), microcontroller, or microprocessor.

The transmitting device processor 46, the receiving device processor 54, and the remote system processor 56 each may execute program code stored in a non-transitory computer readable medium, such as random access memory (RAM), a read-only memory (ROM), an erasable programmable read-only memory (EPROM or Flash memory), or any other suitable memory device incorporated into the distance measuring system 40 or in a separate memory device, to carry out operation of the transmitting device 42, the receiving device 48, and/or the distance measuring system 40, respectively. It will be apparent to a person having ordinary skill in the art of computer programming how to program the processors 46,54,56 to operate and carry out the functions associated with their respective device and/or system. Accordingly, details as to specific programming code have been left out for the sake of brevity. Also, while the code may be executed by the processors 46, 54, 56 in accordance with an exemplary embodiment, such functionality may also be carried out via dedicated hardware, firmware, software, or combinations thereof, without departing from the scope of the invention.

The distance of the receiving device 48 from the transmitting device 42 may be calculated based on a difference between the RF signal receipt time and the US signal receipt time. With reference to the timing diagram in FIG. 2c, in particular, the US signal transmission time is depicted as TX_{S} and the RF signal transmission time is depicted as TX_{R}. As compared to conventional configurations, with the use of a single transmitter 44 capable of simultaneous transmission of RF and US signals, such as for example a plasma transmitter, TX_{S} and TX_{R} effectively are the same, which as detailed more below eliminates the discrepancies experienced in conventional configurations. The RF signal receipt time is depicted as RX_{R} and the US signal receipt time is depicted as RX_{S}. In the distance measuring system 40, the difference in receipt time of the RF signal and the US signal is considered the ToF of the US signal because the ToF of the RF signal is negligible with regards to the ToF of the US signal for the same distance. Therefore, using the speed of sound, the distance of the receiving device 20 from the transmitting device 12 may be calculated, again for example by the formula: Distance=ToF_{S}×Speed of Sound, where ToF_{S}=RX_{S}−RX_{R}.

In an example, graphically depicted in FIG. 2d, where a US signal and an RF signal are simultaneously transmitted from a single transmitter, such as for example a plasma transmitter or a corona discharge transmitter in particular, the difference in receipt of the RF signal and the US signal is depicted. The first peak R depicted in FIG. 2d represents the RF signal and the second peak S represents the US signal, both recorded by the receiving device at a distance of 100 millimeters from the transmitter. The distance between R and S is therefore considered the ToF of the US signal and the distance of the receiving device from the transmitting device may be calculated accordingly.

Unlike the conventional distance measuring system 10 and the conventional distance calculation, the distance calculation of the distance measuring system 40 does not include any system delay as the US signal transmission time and the RF signal transmission time are exactly the same due to the simultaneous transmission of the RF and US signals from the transmitter 44. Accordingly, distance calculation errors and the need to manually account for group delay and antenna delay may be reduced or wholly eliminated according to the distance measuring system of the present invention.

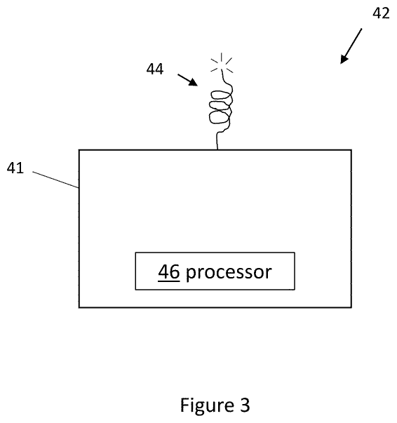

Referring to FIG. 3, an exemplary second (transmitting) device 42 for use in a distance measuring system, such as the distance measuring system 40 previously described, is depicted. The transmitting device 42 is located at a distance from a receiving device, such as the receiving device 48 in the distance measuring system 40. The transmitting device 42 may comprise a housing 41. As previously described for the transmitting device 42 in the distance measuring system 40, the transmitting device 42 comprises a transmitter 44 configured to simultaneously transmit both an electromagnetic signal and a sound signal. The transmitter 44 of the transmitting device 42 is capable of simultaneous transmission of the electromagnetic and sound signals. In an embodiment, the transmitter 44 of the transmitting device 42 may be a plasma transmitter such as, for example, a corona discharge transmitter. The transmitter 44 may transmit the electromagnetic signal as, for example, a radio signal, also referred to herein as an RF signal. The transmitter 44 also may transmit the sound signal as, for example, an ultrasound (US) signal. The sound, or US, signal may be transmitted within a wide range of frequencies. For example, the US signal may be transmitted from approximately 20-40 kHz, although the precise range is not critical. The electromagnetic, or RF, signal may be transmitted within a wide range of ordinary radio frequencies. Again, for simplicity RF and US are used to refer to the electromagnetic and sound signals, respectively, though it is to be understood that the electromagnetic and sound signals are not limited to RF and US signals, specifically, but may be any suitable electromagnetic or sound signal. The transmitting device 42 also includes the transmitting device processor 46 for controlling the transmitting device 42.

The RF signal transmitted by the transmitting device 42 is receivable by the receiving device at a first, or RF signal receipt time and the US signal is receivable by the receiving device at a second, or US signal receipt time. Accordingly, the distance of the receiving device from the transmitting device 42 may be calculated based on a difference between the RF signal receipt time and the US signal receipt time, as previously described with respect to the distance measuring system 40.

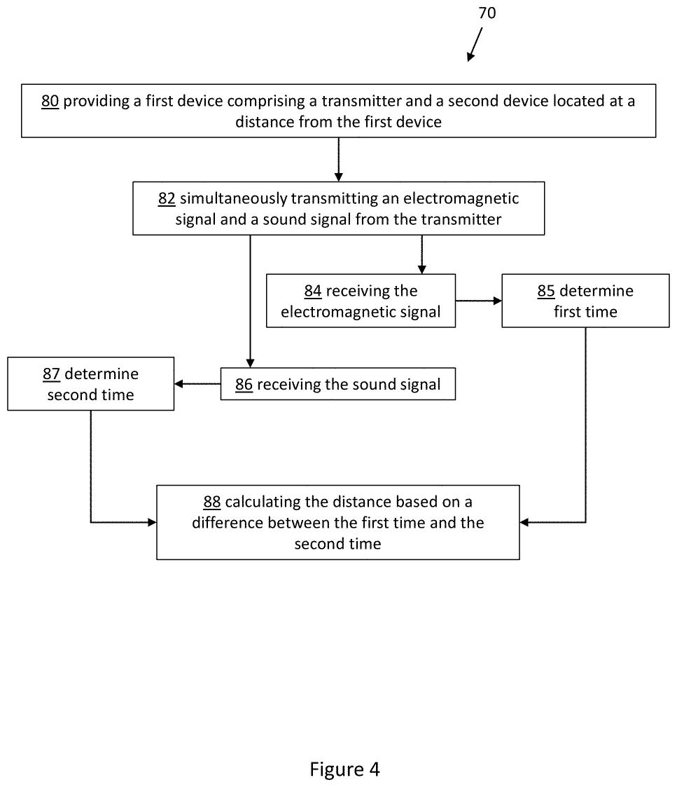

With reference to FIG. 4, a method 70 of measuring distance according to another aspect of the present invention is depicted. The method 70 includes, at step 80, providing a first (transmitting) device and a second (receiving) device located at a distance from the transmitting device. The method 70 may also include providing a processor. The processor may be a transmitting device processor such as the transmitting device processor 46 previously described, a receiving device processor such as the receiving device processor 54 previously described, or a remote system processor such as the remote system processor 56 previously described. The transmitting device comprises a transmitter capable of simultaneously transmitting an electromagnetic signal and a sound signal. In an example, the transmitter may be a plasma transmitter such as, for example, a corona discharge transmitter.

Accordingly, the method 70 includes, at step 82, simultaneously transmitting an electromagnetic signal and a sound signal from the transmitter of the transmitting device. The method 70 may include transmitting the electromagnetic signal as a radio signal, also referred to herein as an RF signal, and transmitting the sound signal as an ultrasound (US) signal. For simplicity, RF and US again are used throughout to refer to the electromagnetic and sound signals, respectively, though it is to be understood that the electromagnetic and sound signals are not limited to RF and US signals, specifically, but may be any suitable electromagnetic or sound signal.

In an embodiment, therefore, the providing, at step 80, may include providing a receiving device comprising an electromagnetic receiver, such as a radio antenna, for receiving the RF signal and a sound receiver, such as a microphone, for receiving the US signal. In another embodiment, the providing, at step 80, may include providing a receiving device comprising a single system receiver configured to receive both the RF signal and the US signal. In this embodiment, the single system receiver may comprise, for example, a receiving plasma antenna. In another example, the single system receiver may be a microphone having microphone circuitry that is subjected to interference by the RF signal. In this example, the microphone may receive the US signal as is conventional for a microphone, and further may receive the RF signal and detect the RF signal by recording the electromagnetic interference in the microphone circuitry.

The method 70 also comprises receiving, at step 84, by the receiving device, the RF signal at a first, or RF signal receipt time. Accordingly, the method comprises determining, at step 85, by the receiving device and/or at least one of the processors, the RF signal receipt time upon receiving the RF signal. Additionally, the method 70 comprises receiving, at step 86, by the receiving device, the US signal at a second, or US signal receipt time. Accordingly, the method comprises determining, at step 87, by the receiving device and/or at least one of the processors, the US signal receipt time upon receiving the US signal. After the RF signal and US signal receipt times are determined, the method 70 comprises calculating, at step 88, by the receiving device and/or at least one of the processors, the distance of the receiving device from the transmitting device based on a difference between the RF signal receipt time and the US signal receipt time. The resulting calculated distance will be more accurate than if calculated by a conventional distance measuring method that includes errors due to various delays in conventional distance measuring systems after initiating the RF and/or US signals.

According to the method of the present invention, the distance calculation errors and the need to manually account for group delay and antenna delay are reduced or wholly eliminated by providing at step 80 a transmitter capable of simultaneously transmitting electromagnetic and sound signals, and by simultaneously transmitting 82 the electromagnetic and sound signals.

According to an aspect of the invention, a distance measuring system is provided. The distance measuring system comprises a first device comprising a transmitter configured to simultaneously transmit an electromagnetic signal and a sound signal. The distance measuring system also comprises a second device located at a distance from the first device. The second device is configured to receive the electromagnetic signal at a first time and receive the sound signal at a second time, and calculate the distance of the second device from the first device based on a difference between the first time and the second time.

In an embodiment, the transmitter of the first device is a plasma transmitter.

In another embodiment, the plasma transmitter is a corona discharge transmitter.

In yet another embodiment, the second device of the distance measuring system comprises an electromagnetic receiver configured to receive the electromagnetic signal and a sound receiver configured to receive the sound signal.

In another embodiment, the electromagnetic receiver of the second device is a radio antenna and the sound receiver of the second device is a microphone.

In yet another embodiment, the second device of the distance measuring system comprises a single system receiver configured to receive both the electromagnetic signal and the sound signal.

In an embodiment, the single system receiver comprises a receiving plasma antenna.

In another embodiment, the single system receiver comprises a microphone having microphone circuitry. The microphone is configured to receive the sound signal and to receive the electromagnetic signal, and further is configured to detect the electromagnetic signal from electromagnetic interference in the microphone circuitry.

In yet another embodiment, the first device transmits the electromagnetic signal as a radio signal.

According to another aspect of the invention, a method of measuring distance is provided. The method comprises providing a first device and a second device located at a distance from each other. The method comprises simultaneously transmitting, by the first device, an electromagnetic signal and a sound signal. The method also comprises receiving, by the second device, the electromagnetic signal at a first time, and receiving, by the second device, the sound signal at a second time. The method then comprises calculating, by the second device, the distance of the second device from the first device based on a difference between the first time and the second time.

In an embodiment, the transmitter of the first device in the method is a plasma transmitter.

In another embodiment, the plasma transmitter is a corona discharge transmitter.

In an embodiment, the providing in the method comprises providing a second device that comprises an electromagnetic receiver for receiving the electromagnetic signal and a sound receiver for receiving the sound signal.

In another embodiment, the electromagnetic receiver is a radio antenna and the sound receiver is a microphone.

In yet another embodiment, the providing in the method comprises providing a second device that comprises a single system receiver configured to receive both the electromagnetic signal and the sound signal.

In an embodiment, the single system receiver is a receiving plasma antenna.

In another embodiment, the single system receiver comprises a microphone having microphone circuitry. The microphone is configured to receive the sound signal and to receive the electromagnetic signal, and further is configured to detect the electromagnetic signal from electromagnetic interference in the microphone circuitry.

In yet another embodiment, the transmitting in the method comprises transmitting the electromagnetic signal as a radio signal.

According to another aspect of the invention, a non-transitory computer-readable medium storing program code is provided which when executed performs the steps of simultaneously transmitting, by a first device, an electromagnetic signal and a sound signal, wherein the first device is located at a distance from a second device, receiving, by the second device, the electromagnetic signal at a first time, receiving, by the second device, the sound signal at a second time, and calculating, by the second device, the distance of the second device from the first device based on a difference between the first time and the second time.

According to an aspect of the invention, a first device located at a distance from a second device is provided. The first device comprises a transmitter configured to simultaneously transmit an electromagnetic signal and a sound signal. The electromagnetic signal is receivable by the second device at a first time and the sound signal is receivable by the second device at a second time, such that the distance of the second device from the first device is calculated based on a difference between the first time and the second time.

In an embodiment, the transmitter of the first device is a plasma transmitter.

In another embodiment, the plasma transmitter is a corona discharge transmitter.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A distance measuring system comprising:
a first device comprising a transmitter configured to simultaneously transmit an electromagnetic signal and a sound signal,
a second device located at a distance from the first device, the second device comprising a single system receiver comprising a microphone having microphone circuitry, the microphone being configured to receive the electromagnetic signal at a first time and receive the sound signal at a second time, the microphone further being configured to detect the electromagnetic signal from the electromagnetic interference in the microphone circuitry,
wherein the second device is configured to calculate the distance of the second device from the first device based on a difference between the first time and the second time.

2. The distance measuring system of claim 1, wherein the transmitter is a plasma transmitter.

3. The distance measuring system of claim 2, wherein the plasma transmitter is a corona discharge transmitter.

4. The distance measuring system of claim 1, wherein the first device is configured to transmit the electromagnetic signal as a radio signal.

5. The distance measuring system of claim 1, wherein the first device is configured to transmit the sound signal as an ultrasound signal.

6. The distance measuring system of claim 1 , wherein the first device comprises a first device processor for controlling the first device.

7. The distance measuring system of any of claim 1 , wherein the second device comprises a second device processor for controlling the second device.

8. The distance measuring system of claim 1, further comprising a remote system processor in wireless communication with the first device and the second device for controlling the first device and the second device.

9. A method of measuring distance, comprising the steps of:
providing a first device and a second device located at a distance from each other,
simultaneously transmitting, by a transmitter of the first device, an electromagnetic signal and a sound signal,
receiving, by a single system receiver of the second device, the electromagnetic signal at a first time,
receiving, by the single system receiver of the second device, the sound signal at a second time, and
calculating, by the second device, the distance of the second device from the first device based on a difference between the first time and the second time;
wherein the single system receiver of the second device comprises a microphone having microphone circuitry, and the microphone receives the electromagnetic signal at the first time and receives the sound signal at the second time, and the microphone further detects the electromagnetic signal from the electromagnetic interference in the microphone circuitry.

10. The method of claim 9, wherein the transmitter of the first device is a plasma transmitter.

11. The method of claim 10, wherein the plasma transmitter is a corona discharge transmitter.

12. The method of claim 9, wherein the transmitting comprises transmitting the electromagnetic signal as a radio signal.

13. The method of claim 9, wherein the transmitting comprises transmitting the sound signal as an ultrasound signal.

14. The method of claim 9, wherein the transmitting comprises transmitting the sound signal in a frequency range of 20-40 kHz.

15. A computer-readable medium storing program code which when executed performs the steps of:
simultaneously transmitting, by a transmitter of a first device, an electromagnetic signal and a sound signal, wherein the first device is located at a distance from a second device,
receiving, by a single system receiver of the second device, the electromagnetic signal at a first time,
receiving, by the single system receiver of the second device, the sound signal at a second time, and
calculating, by the second device, the distance of the second device from the first device based on a difference between the first time and the second time;
wherein the single system receiver of the second device comprises a microphone having microphone circuitry, and the program code is executed to control the microphone to receive the electromagnetic signal at the first time and receive the sound signal at the second time, and to control the microphone further to detect the electromagnetic signal from the electromagnetic interference in the microphone circuitry.

16. The computer-readable medium storing program code of claim 15, wherein the transmitter of the first device is a plasma transmitter.

17. The computer-readable medium storing program code of claim 16, wherein the plasma transmitter is a corona discharge transmitter.

18. The computer-readable medium storing program code of claim 15, which when executed performs the transmitting step by transmitting the electromagnetic signal as a radio signal.

19. The computer-readable medium storing program code of claim 15, which when executed performs the transmitting step by transmitting the sound signal as an ultrasound signal.

20. The computer-readable medium storing program code of claim 15, which when executed performs the transmitting step by transmitting the sound signal in a frequency range of 20-40 kHz.
